(19) United States
(12) Patent Application Publication
(10) Pub. No.: US 2015/0187023 A1
(43) Pub. Date: Jul. 2, 2015

(54) System Containing An Integration Of Cost Savings Tracker And Spend Analyzer For Calculating Actual Effective Savings

(71) Applicants: PRASAD NAIR, MUMBAI (IN); BIKASH MOHANTY, MUMBAI (IN)

(72) Inventors: PRASAD NAIR, MUMBAI (IN); BIKASH MOHANTY, MUMBAI (IN)

(21) Appl. No.: 14/658,200

(22) Filed: Mar. 15, 2015

Related U.S. Application Data
(63) Continuation-in-part of application No. 13/607,713, filed on Sep. 8, 2012, now abandoned.
Application No. 13/607,713 is a continuation-in-part of application No. 14/461,686, filed on Aug. 18, 2014, now abandoned.

(30) Foreign Application Priority Data
Jun. 7, 2012 (IN) 1669/MUM/2012

(51) Int. Cl. G06Q 40/00

(52) U.S. Cl. CPC G06Q 40/12

(57) ABSTRACT

A system containing an integration of a cost savings tracker and spend analyzer for calculating actual effective savings of a spend category in a procurement cycle is described. The system includes a cost savings tracker module and spend analyzer module. The cost savings tracker module facilitates computation of actual effective cost savings of a spend category and thus facilitates tracking of the cost savings of a spend category, while a cost component model of the spend analyzer module is intended for spend analysis that facilitates analysis of the procurement cost in relation to market indices of the underlying commodities.

### CROSS-REFERENCE TO RELATED APPLICATION

The instant application is a continuation-in-part of U.S. patent application Ser. No. 14/461,686, filed Aug. 18, 2014, pending, is a continuation-in-part of U.S. patent application Ser. No. 13/607,713, filed Sep. 8, 2012, abandoned, and claims priority to Indian Patent Application Ser. No. 1669/MUM/2012, filed Jun. 7, 2012, pending, the entire specifications of all of which are expressly incorporated herein by reference.

### FIELD OF THE INVENTION

The present invention relates generally to the field of information and computation systems, and more particularly, to the field of information and computation systems in relation to procurement cost savings. More specifically, the present invention relates to procurement systems and methods to facilitate the calculation of the actual effective savings of a spend category and optimization of procurement costs.

### BACKGROUND OF THE INVENTION

Cost savings achieved while procuring goods is an indication of the performance/effectiveness of a procurement department of an organization. It is very important for procurement departments to keep track of savings across each stage of the procurement process until the time of the actual purchasing of goods and/or services.

In a traditional way of computing cost savings, cost savings are typically tracked in an Excel™ spreadsheet and there is no system to capture the savings from multiple sources.

Accordingly, there exists a need for new and improved systems and methods to facilitate the calculation of the actual effective savings of a spend category and optimization of procurement costs.

### SUMMARY OF THE INVENTION

The present invention provides a system and method containing an integration of a cost savings tracker and spend analyzer, which is meant for calculating the actual effective cost savings of a spend category in a procurement cycle.

In the present invention, this important task of computing cost savings and tracking of cost savings is done by a cost savings tracker module of the system, while optimization of the procurement costs in light of market dynamics of the underlying commodities is facilitated by a spend analyzer module of the system. Market information of the spend category for which cost savings are to be calculated, is received from the cost component model of the spend analyzer module of the system. This cost component model of the spend analyzer module is based on market indices for key spend categories and analyzing customer spend data with it.

An object of the present invention is to provide a system containing an integration of the cost savings tracker and the spend analyzer to calculate the actual effective savings of a spend category in a procurement cycle.

A further object of the present invention is to provide a system containing an integration of the cost savings tracker and the spend analyzer to determine the market trend of a spend category based on the cost component model of the spend analyzer module.

The present invention includes a system containing an integration of the cost savings tracker and the spend analyzer for calculating the actual effective savings of a spend category in a procurement cycle. In the present invention, the cost savings tracker module of the system is meant for calculating different types of savings of a spend category done by the procurement department in a procurement cycle, based upon the baseline cost information, the purchase cost information of the spend category and receiving average price change market information of that spend category. This market information of a spend category is received from the cost component model of the spend analyzer module of the system associating an indication of the plurality of the components for the cost saving which are computed for the spend category with the average price change market information of that spend category derived from the cost component model of spend analyzer, and outputting an analysis of the effective savings of that spend category based upon a pre-configured formula.

The cost savings tracker module of the present system facilitates computation of the actual effective cost savings of a spend category and thus facilitates tracking of the cost savings of a spend category.

The cost component model of the spend analyzer module of the present system is meant for spend analysis which facilitates analysis of the procurement cost in relation to the market indices of the underlying commodities.

In accordance with one embodiment of the present invention, a system for analyzing effective cost savings is provided, wherein there is an interconnection of at least one configurable and namable business process element, comprising:

a host computer system;

at least one database component operably associated with the host computer system;

a communication interface for accessing the host computer system from a plurality of remote input/output devices to manage the analysis of effective cost savings for the business process element;

a cost savings tracker module operably associated with the host computer system and including a cost savings computing system adapted for computing a plurality of components for cost savings for a spend category;

a cost component model of a spend analyzer module operably associated with the hoist computer system and adapted for receiving average price change market information of the spend category; and

a system operably associated with the computer system and adapted for outputting and converting an analysis of cost savings of the spend category in a web form based upon a pre-configured formula.

In accordance with another embodiment of the present invention, a method for analyzing effective cost savings is provided, wherein there is an interconnection of at least one configurable and namable business process element, comprising:

providing a host computer system;

providing at least one database component operably associated with the host computer system;

providing a communication interface for accessing the host computer system from a plurality of remote input/output devices to manage the analysis of effective cost savings for the business process element;

providing a processor unit operably associated with the host computer system;

providing a computer readable medium storing instructions executable by the processor unit to perform the steps of:

computing a plurality of components for cost savings for a spend category;

receiving average price change market information of the spend category from a cost component model of a spend analyzer module; and

outputting and converting an analysis of the cost savings of the spend category in a web form based upon a pre-configured formula.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates the primary data flow in a general procurement cycle, in accordance with a first embodiment of the present invention;

FIG. 2 illustrates a schematic of a cost savings tracker module and a spend analyzer module for calculating actual effective cost savings of a spend category in the procurement cycle, in accordance with a second embodiment of the present invention; and

FIG. 3 illustrates a cost component model for ball bearings, in accordance with a third embodiment of the present invention.

### DETAILED DESCRIPTION OF THE INVENTION

The following description of the preferred embodiment(s) is merely exemplary in nature and is in no way intended to limit the invention, or uses.

In accordance with one embodiment of the present invention, a system for analyzing effective cost savings is provided, wherein there is an interconnection of at least one configurable and namable business process element, comprising a host computer system, at least one database component operably associated with the host computer system, a communication interface for accessing the host computer system from a plurality of remote input/output devices to manage the analysis of effective cost savings for the business process element, a cost savings tracker module operably associated with the host computer system and including a cost savings computing system adapted for computing a plurality of components for cost savings for a spend category, a cost component model of a spend analyzer module operably associated with the hoist computer system and adapted for receiving average price change market information of the spend category, and a system operably associated with the computer system and adapted for outputting and converting an analysis of cost savings of the spend category in a web form based upon a pre-configured formula.

In accordance with another embodiment of the present invention, a method for analyzing effective cost savings is provided, wherein there is an interconnection of at least one configurable and namable business process element, comprising providing a host computer system, providing at least one database component operably associated with the host computer system, providing a communication interface for accessing the host computer system from a plurality of remote input/output devices to manage the analysis of effective cost savings for the business process element, providing a processor unit operably associated with the host computer system, providing a computer readable medium storing instructions executable by the processor unit to perform the steps of computing a plurality of components for cost savings for a spend category, receiving average price change market information of the spend category from a cost component model of a spend analyzer module, and outputting and converting an analysis of the cost savings of the spend category in a web form based upon a pre-configured formula.

For example, the user could provide the requisite input/data on a handheld mobile device (e.g., cellular phone, smartphone, PDA, laptop computer, tablet computer, and/or any other like device that is selectively operable to communicate with the host computer system (or component thereof) through a wired and/or wireless connection) for which analysis, outputting and/or conversion needs to be done.

With respect to the phrase “web form,” as that term is used herein, forms can be made up of standard graphical user interface elements, such as but not limited to: (1) text input—a simple text box that allows input of a single line of text (an alternative, password, may be used for security purposes, in which the character typed in may be invisible or replaced by symbols such as *); (2) radio—a radio button; (3) file—a file select control for uploading a file; (4) reset—a reset button that, when activated, may tell the browser to restore the values to their initial values; (5) submit—a button that may tell the browser to take action on the form (typically to send it to a server); (6) textarea—much like the text input field except a textarea may allow for multiple rows of data to be shown and entered; and/or (7) select—a drop-down list that may display a list of items a user can select from. Forms may be enclosed in an HTML form tag. This tag may specify the communication endpoint the data entered into the form should be submitted to, and the method of submitting the data, GET or POST.

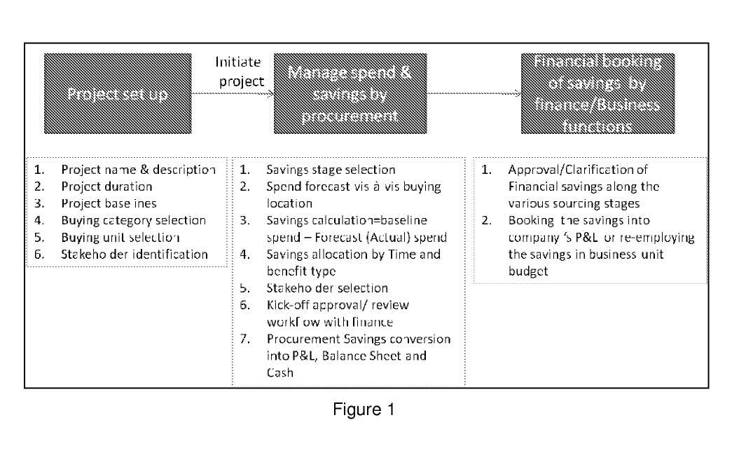

FIG. 1 illustrates a data flow of a procurement process in the cost savings tracker module of the present system. As shown in FIG. 1, at the initial stages of a new project, procurement professionals forecast the procurement cost savings of the new project. These procurement cost savings are generally determined as (baseline spend—new spend). This baseline spend is a reference spend, that is defined by the buyer and it is the average of last “n” months of price of that spend category defined by a commodity index. The cost savings tracker module of the present system provides this information of the spend category to the user from its spend analysis, if the baseline spend is calculated using historical data. Whereas, if the baseline spend is determined by a commodity index, the spend analyzer module of the present invention provides commodity related information.

In one of the embodiments of the present invention, the cost savings tracker module of the system facilitates tracking of cost savings based on its different components in the procurement cycle, e.g., “benefit type component,” “impact type component,” etc. It also facilitates to find the component of cost savings that has an impact on the balance sheet, and thus an indication of the performance of the procurement department. It also facilitates finding out the component of cost savings that is an indication of an effective negotiation with the supplier.

In another embodiment of the present invention, market information of the spend category for which cost savings are to be calculated, is received from the cost component model of the spend analyzer module of the system. This cost component model of the spend analyzer module is meant for spend analysis, which facilitates analysis of the procurement cost in relation to market indices of the underlying commodities. The cost component model for a spend category provides relative significance of the cost drivers based on these market indices. This in turn enables the purchasing professionals to take actions to optimize spend.

In still another embodiment of the present invention, pre-configured cost component models are provided. The user is allowed to select the cost component model from those that are appropriate for the spend category of interest. In this embodiment, the user can also modify the selected pre-configured cost component model to better suit the spend category. In an alternative embodiment, the user can formulate the cost component model for the spend category by way of selecting individual cost contributors and assigning weightages to them.

### Example 1

| | | | | | Savings due to |
|---|---|---|---|---|---|
| | Unit | | Total | | effective negotiation |
| | price | Quantity | cost | Savings | (Qty constant) |
| Year 2010 | 40 | 20 | 800 | 200 | 200 |
| Year 2011 | 30 | 20 | 600 | | |

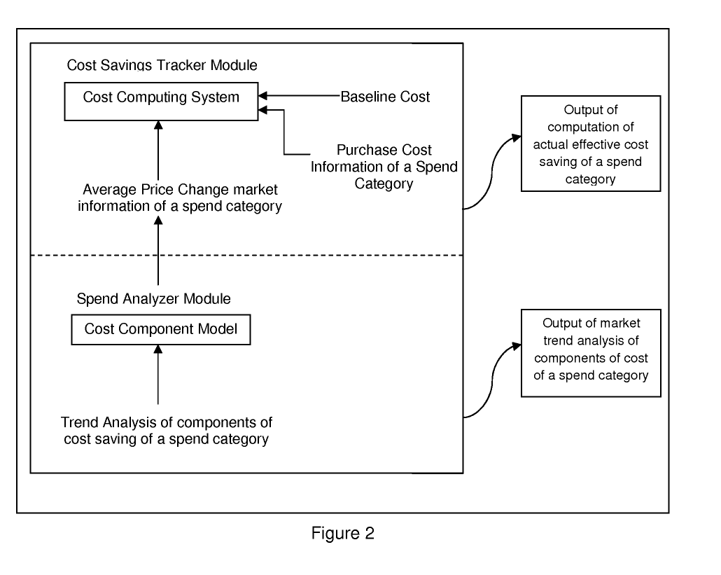

In the above example, baseline spend (800) is taken from a historical database, and after deducting actual spends for the year 2011, a savings of 200 is arrived at. To know whether this negotiated saving is an actual effective saving or not, a spend analyzer is integrated with a cost savings tracker, and thus, the trend of a market price for this commodity can then be determined (e.g., by comparing the price of that commodity in the year 2010). An illustrative example of such a system is shown in FIG. 2.

Suppose that in the year 2011, the price trend is decreased by 10% from the last year's price. So the baseline price would be 720, instead of 800, and actual effective saving would be 120, instead of 200.

This actual effective saving is calculated by the formula: B+(% C*B)−P

e.g., 800+(−10% of 800)−600=120

### Example 2

Let's take an example of a cost component model for ball bearings.

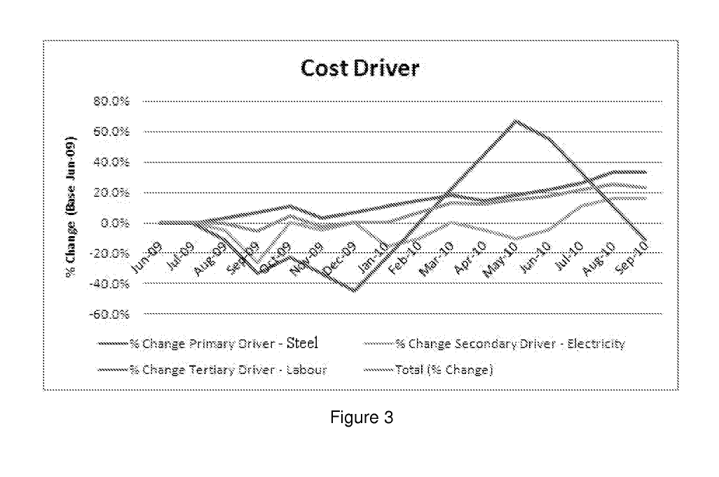

The cost contributors are stainless steel, labor and electricity and if their significance of contribution to the cost is 40%, 16% and 10%, respectively, the trend of individual cost components, as well as cumulative trend, based on relative changes of contributing cost drivers for one time period, is shown in FIG. 3.

By way of a non-limiting example, a demonstration of the practical usefulness of the present invention will now be described below.

The market trend module may suggest a market trend based on different geographical regions, wherein the user can decide between different modules of market trends based on various regions.

By way of a non-limiting example, a user in the United States may also know a market trend for that cost contributor in the United Kingdom. That is, the system has a robust database to provide comparative market trends for different regions across the globe.

With respect to system intelligence, the market trends may suggest a trend by the cost contributors and may also be mapped against a database of the last 12 month trend for that cost contributor. The system may also provide a database of the last 12 month trend for that cost contributor to suggest to the user as to which month, generally, the trend of that cost contributor rises up and in which month the trend of that cost contributors subsides.

The system may also provide a comparative analysis of the market trend of different regions, wherein the system is also integrated with a supplier database to tie up a suggested supplier for that item in the regions where the item market trend is low.

For example, for copper and steel, the user may decide between different modules of market trends based on regions, wherein the system may provide region-wise analysis of the copper and steel market trends, wherein the system may show that the market trend of copper in California is higher compared to the market trend of steel in California is low compared to New Jersey. Therefore, it may suggest to buy copper from New Jersey, whereas it may suggest to buy steel from California.

Further the system may be tied up to a supplier database, and accordingly based on mapping of the identification of an item with region and with supplier, the system may suggest suppliers for that region for that item. Further, the system may be integrated with the database of supplier performance to fetch reports of the supplier performance, its ratings, and, for that item, showing the trend of cost at which the supplier had provided that item in the past. Based on the supplier performance report, the system may provide a supplier satisfaction index.

Thus, the cost components may be tied up with the market index and supplier satisfaction index for the named suppliers suggested by the system. This provides the user with system suggestions for the user to decide from which region, and from which supplier, and/or in which month, the user should buy the component or how many months the user ideally should wait to buy the component.

With respect to converting the user input into user configurable cost component models, the customer's spend category may be matched with those categories for which the cost component model exists.

The category for which the cost component model has been built may have a UNSPSC code. The matching could be based on the UNSPSC code, and once it is matched, the cost component model for the category could be associated with the customer's spend category. The tool could be flexible to provide for automatic matching (e.g., based on a UNSPSC code, as discussed above) and manual matching.

The cost component model may be further made user configured. The user configured cost component model may be further validated by a system which is as follows: the cost component model may include a system to validate the user configured cost component model. That is, to validate whether the major cost contributors have been taken or not or any major cost contributor has been left out. The cost component so configured by the user may be validated with the existing industry standard bases of cost component models from the real world. A pattern mapping may be done of the major cost component models with the real world model. The deviations, if any, may be provided on the handheld/mobile device for approval or rejection by the project manager. The handheld/mobile device can include, without limitation, a cellular phone, smartphone, PDA, laptop computer, tablet computer, and/or any other like device that is selectively operable to communicate with the host computer system (or component thereof) through a wired and/or wireless connection) for which analysis, outputting and/or conversion needs to be done. The approved cost component model may be taken forward for analysis.

For manual matching, the cost component model may consist of cost drivers. The cost drivers may be further converted by a system into value added cost drivers. The cost drivers may be converted into value added cost drivers by associating the cost drivers with weightage, which is not only based on the cost, but also based on other significant factors like whether the cost driver is a monopolistic item, and other factors like importance of its presence in the commodity. The value added cost drivers of the cost component model may be further converted into market trend cost drivers by associating the market trends with the cost drivers.

The system could bring market and internal perspectives for analysis purposes. Market information could come from the cost component model based on market indices. Internal information could come from systems based on customer data. For those customer's spend categories for which the cost component model has been matched, detail analysis could be available.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for analyzing effective cost savings, wherein there is an interconnection of at least one configurable and namable business process element, comprising:
a host computer system;
at least one database component operably associated with the host computer system;
a communication interface for accessing the host computer system from a plurality of remote input/output devices to manage the analysis of effective cost savings for the business process element;
a cost savings tracker module operably associated with the host computer system and including a cost savings computing system adapted for computing a plurality of components for cost savings for a spend category;
a cost component model of a spend analyzer module operably associated with the hoist computer system and adapted for receiving average price change market information of the spend category; and
a system operably associated with the computer system and adapted for outputting and converting an analysis of cost savings of the spend category in a web form based upon a pre-configured formula.

2. The system as claimed in claim 1, wherein the plurality of the components for cost savings include at least one benefit type component and at least one impact type component.

3. The system as claimed in claim 1, wherein the cost component model is selectively operable to compute cost drivers of the spend category.

4. The system as claimed in claim 1, wherein the cost component model provides relative significance of cost drivers based on market indices, wherein the spend analyzer module tracks the top three cost drivers of the spend category.

5. The system as claimed in claim 1, wherein the cost savings computing system calculates the costs savings by the formula:
B+(% C*B)−P
where,
B=baseline costs of the spend category;
% C=% price change of the cost drivers of the spend category from the market information; and
P=purchase costs of the spend category.

6. The system as claimed in claim 5, wherein the baseline costs of the spend category is determined from an information provider module or entered manually by a user.

7. The system as claimed in claim 5, wherein the % price change of the cost drivers of the spend category from the market information is received from the cost component model of the spend analyzer module.

8. The system as claimed in claim 1, wherein the cost component model of the spend analyzer module shows a market trend for the cost drivers for the spend category.

9. The system as claimed in claim 8, wherein the cost component model of the spend analyzer module further shows the market trend of cost drivers for both direct and indirect spend categories.

10. The system as claimed in claim 1, wherein the cost component model of the spend analyzer module shows a trend of individual cost drivers of the spend category.

11. The system as claimed in claim 1, wherein the cost component model of the spend analyzer module calculates a cumulative trend of cost drivers based on relative changes of contributing cost drivers for a specified time period.

12. The system as claimed in claim 1, wherein the cost component model of the spend analyzer module shows the effect of individual cost drivers on a cumulative market trend of the spend category.

13. The system as claimed in claim 1, wherein the system provides a user to modify already available cost models and to create a new cost model.

14. A method for analyzing effective cost savings, wherein there is an interconnection of at least one configurable and namable business process element, comprising:
providing a host computer system;
providing at least one database component operably associated with the host computer system;
providing a communication interface for accessing the host computer system from a plurality of remote input/output devices to manage the analysis of effective cost savings for the business process element;
providing a processor unit operably associated with the host computer system;
providing a computer readable medium storing instructions executable by the processor unit to perform the steps of:
computing a plurality of components for cost savings for a spend category;
receiving average price change market information of the spend category from a cost component model of a spend analyzer module; and
outputting and converting an analysis of the cost savings of the spend category in a web form based upon a pre-configured formula.

15. The method as claimed in claim 14, wherein the plurality of the components for cost savings include at least one benefit type component and at least one impact type component.

16. The method as claimed in claim 14, wherein the cost component model is selectively operable to compute cost drivers of the spend category.

17. The method as claimed in claim 14, wherein the cost component model provides relative significance of cost drivers based on market indices, and wherein the spend analyzer module tracks the top three cost drivers of the spend category.

18. The method as claimed in claim 14, wherein the actual effective savings is calculated by the formula:
B+(% C*B)−P
where,
B=baseline costs of the spend category;
% C=% price change of the cost drivers of the spend category from the market information; and
P=purchase costs of the spend category.

19. The method as claimed in claim 18, wherein the baseline costs of the spend category is determined from an information provider module or entering manually by a user.

20. The method as claimed in claim 18, wherein the value of the % price change of the cost drivers of the spend category from the market information is received from the cost component model of the spend analyzer module.

21. The method as claimed in claim 14, wherein the cost component model of the spend analyzer module shows the market trend for the cost drivers for the spend category.

22. The method as claimed in claim 21, wherein the cost component model of the spend analyzer module shows the market trend of the cost drivers for both direct and indirect categories.

23. The method as claimed in claim 14, wherein the cost component model of the spend analyzer module shows the trend of individual cost drivers of the spend category.

24. The method as claimed in claim 14, wherein the cost component model of the spend analyzer module calculates a cumulative trend of cost drivers based on relative changes of contributing cost drivers for a specified time period.

25. The method as claimed in claim 14, wherein the cost component model of the spend analyzer module shows an effect of individual cost drivers on a cumulative market trend of the spend category.

26. The method as claimed in claim 14, further providing the step of providing a user to modify already available cost models and to create a new cost model.
